(19) United States
(12) Patent Application Publication
(10) Pub. No.: US 2015/0096334 A1
(43) Pub. Date: Apr. 9, 2015

(54) Liquor bottle security device

(71) Applicant: Jianmeng SHI, GUANGDONG PROVINCE (CN)

(72) Inventor: Jianmeng SHI, GUANGDONG PROVINCE (CN)

(21) Appl. No.: 14/499,258

(22) Filed: Sep. 29, 2014

(30) Foreign Application Priority Data
Oct. 8, 2013 (CN) 201320618467.3

(51) Int. Cl. E05B 73/00

(52) U.S. Cl. CPC E05B 73/0041
USPC 70/14

(57) ABSTRACT

A liquor bottle security device comprising a housing; wherein the housing comprises a sleeve portion and a security portion provided on one side of the sleeve portion; a locking assembly is installed inside the security portion; the locking assembly comprises a toothed sliding block, a toothed piece and a fastening assembly; a reset spring is provided between the toothed sliding block and the housing; a compression spring is provided between the toothed piece and an inner side wall of the security portion, so that the toothed piece is pressed against a sliding block toothed surface of the toothed sliding block; the toothed sliding block is provided with an inclined drive surface; the inclined drive surface contacts with the fastening assembly movably disposed in the housing; the fastening assembly comprises at least one fastening plate having an arc-shaped fastening groove.

### BACKGROUND OF THE INVENTION

The present invention relates to the technical field of anti-theft devices, and more specifically relates to a kind of liquor bottle security device which can be used as a liquor bottle security tag in shopping malls.

Nowadays, a liquor bottle security device commonly available in a shopping mall is an electronic security tag comprising a steel cable and a strong magnetic lock. To a large extent, this kind of security tag can prevent bottled liquor from being stolen, but it cannot effectively prevent people from opening the bottle and emptying its contents inside the shopping mall.

Although there are some liquor bottle security locks which are intended to lock the bottle caps from being opened, these liquor bottle security locks are susceptible to prying. Also, these liquor bottle security locks contain serious defects such as adverse effect on access control sensor alarm due to their use of excessive number of metal parts. In spite of the locking effect on bottle caps, the liquor bottle security locks may easily damage the protective film provided on the bottle necks and thus seriously damage the outer appearance of the bottles when thieves or customers pull the liquor bottle security locks because the liquor bottle security locks are fastened and tightened on the bottle necks via metal fastening components.

### BRIEF SUMMARY OF THE INVENTION

In view of the aforesaid disadvantages now present in the prior art, the present invention provides a kind of liquor bottle security device which is structurally simple and which has more comprehensive anti-theft performance and stronger anti-theft sensing ability and which also provides better protection to the outer appearance of liquor products.

To attain the above objects, the present invention adopts the following technical proposal:

A liquor bottle security device comprises a housing; the housing comprises a sleeve portion and a security portion provided on one side of the sleeve portion; a locking assembly is installed inside the security portion; the locking assembly comprises a toothed sliding block, a toothed piece and a fastening assembly; a reset spring is provided between the toothed sliding block and the housing; a sliding block toothed surface of the toothed sliding block and a toothed surface of the toothed piece are cooperative with each other; the sliding block toothed surface of the toothed sliding block and the toothed surface of the toothed piece also engage with each another; the toothed sliding block is capable to only slide downwardly with respect to the toothed piece; a compression spring is provided between the toothed piece and an inner side wall of the security portion, so that the toothed piece is pressed against the sliding block toothed surface of the toothed sliding block; the toothed sliding block is provided with an inclined drive surface; the inclined drive surface contacts with the fastening assembly movably disposed in the housing; the fastening assembly comprises at least one fastening plate having an arc-shaped fastening groove.

A bottle neck fastening strip can be provided on the at least one fastening plate; the bottle neck fastening strip is tilted upwardly; when the at least one fastening plate is fastened on a bottle neck tightly, the bottle neck fastening strip abuts against the bottle neck.

The fastening assembly comprises a support rack and two fastening plates mounted on the support rack; the two fastening plates are mounted on an upper end portion and a lower end portion of the support rack respectively.

Two side walls of the toothed sliding block are provided with sliding rails; sliding grooves corresponding to the sliding rails are provided on the fastening assembly; the sliding rails of the toothed sliding block are inserted to the sliding grooves to drive the fastening assembly to move laterally.

The toothed sliding block is connected with an operation handle; the operation handle extends out of an upper cover of the housing; the toothed sliding block is driven by the operation handle when the operation handle is pressed downwardly; the reset spring is provided between a bottom part of the toothed sliding block and a top section of an inner surface of the housing.

The toothed piece is provided with a cylindrical block having a metal surface covering its outer side; the cylindrical block contacts with the compression spring.

One side of the housing is provided with a surface cover which facilitates installation, replacement and maintenance of the locking assembly.

The surface cover is provided with a reset portion; the compression spring is mounted between the reset portion and the toothed piece.

A buffer block is provided between the compression spring and the reset portion.

Compared with the prior art, the present invention has the following advantages: The present invention has a simple structure enabling simple installation, but it is difficult to pry open. Also, the present invention only contains a few metal parts, thereby significantly reducing the adverse effect on access control sensor alarm in shopping malls due to excessive use of metals. Compared with existing metal fastening components, the use of plastic fastening components significantly reduces the damage to the outer appearance of a liquor bottle caused by the security device and reduces the damage to the protective film on the bottle neck of the liquor bottle.

### BRIEF DESCRIPTION OF THE DRAWINGS

FIG. 1 is a perspective view of the liquor bottle security device of the present invention.

FIG. 2 is an exploded view of FIG. 1.

FIG. 3 is a sectional view of the liquor bottle security device of the present invention.

FIG. 4 is a perspective view of the toothed sliding block of the liquor bottle security device of the present invention.

FIG. 5 is an enlarged view showing the engagement between the toothed sliding block and the tooth piece according to the liquor bottle security device of the present invention.

### DETAILED DESCRIPTION OF THE INVENTION

The present invention is further described below with reference to the accompanying figures and an embodiment. It should be understood that the embodiment described herein is only a preferred embodiment. The scope of protection of the present invention should not be limited to the embodiment described herein.

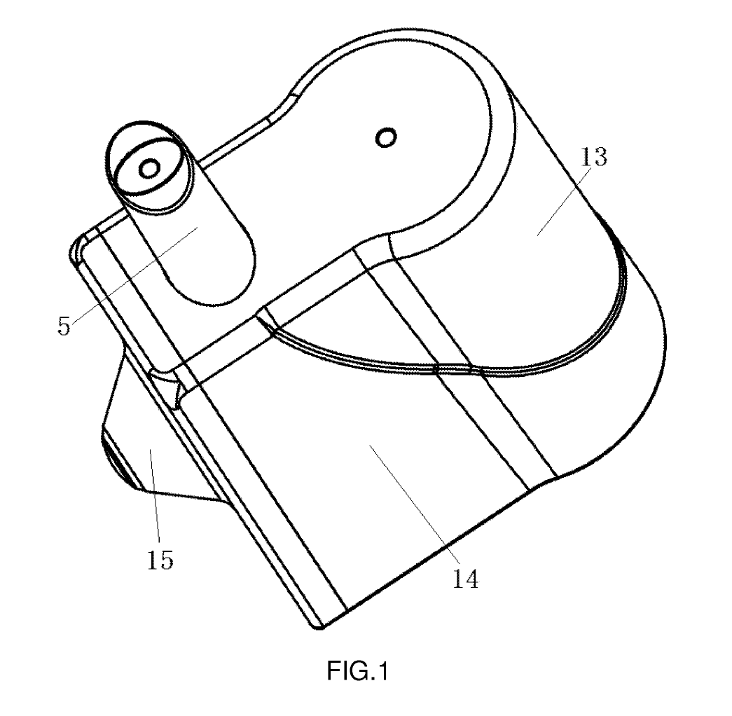

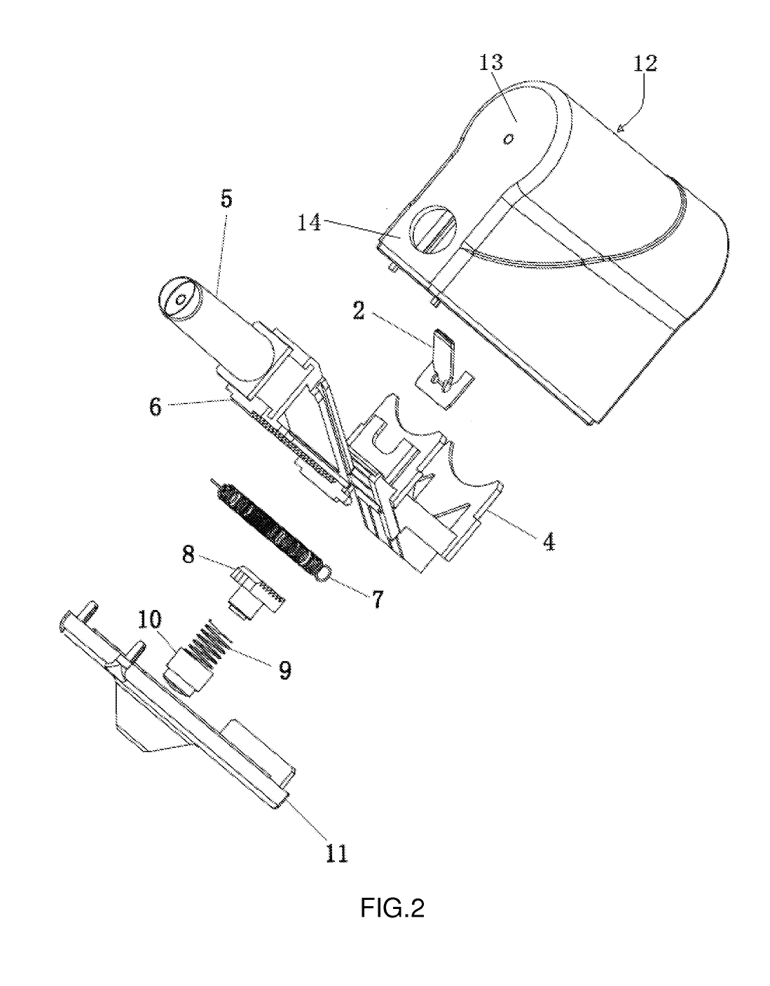

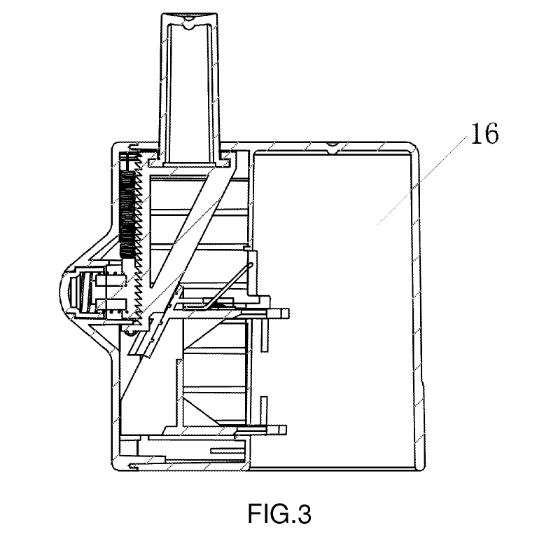

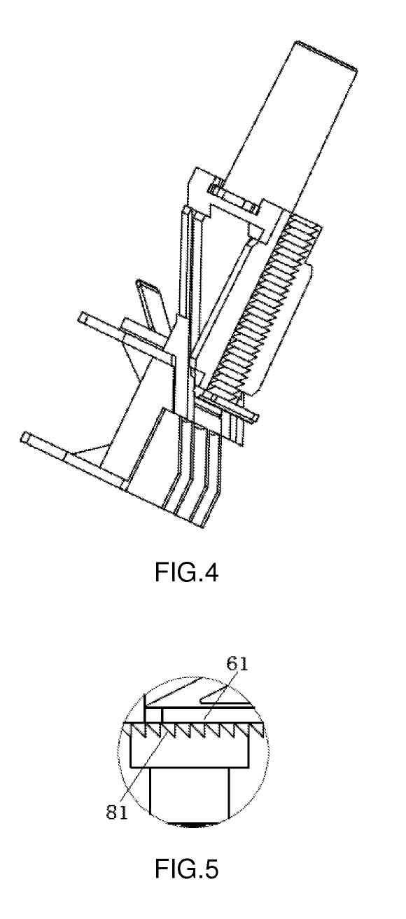

As shown in FIGS. 1-5, a liquor bottle security device of the present invention comprises a housing 12. The housing 12 comprises a sleeve portion 13 having a cavity 16 which sleeves a bottle opening and a bottle neck of a liquor bottle, and a security portion 14 for installing a locking assembly. The locking assembly is installed inside the security portion 14. The locking assembly comprises a toothed sliding block 6, a toothed piece 8 and a fastening assembly. The toothed sliding block 6 is connected with an operation handle 5. The operation handle 5 extends out of an upper cover of the housing 12. The toothed sliding block 6 is driven by the operation handle 5 when the operation handle 5 is pressed downwardly. A reset spring 7 is provided between the toothed sliding block 6 and the housing 12, and is more specifically provided between a bottom part of the toothed sliding block 6 and a top section of an inner surface of the housing 12. A sliding block toothed surface 61 of the toothed sliding block 6 and a toothed surface 81 of the toothed piece 8 are cooperative with each other. The sliding block toothed surface 61 of the toothed sliding block 6 and the toothed surface 81 of the toothed piece 8 also engage with each other. The toothed sliding block 6 can only slide downwardly with respect to the toothed piece 8. A compression spring 9 is provided between the toothed piece 8 and an inner side wall of the housing 12, so that the toothed piece 8 is pressed against the sliding block toothed surface 61 of the toothed sliding block 6. The toothed sliding block 6 is provided with an inclined drive surface. The inclined drive surface contacts with the fastening assembly movably disposed in the housing 12. The fastening assembly comprises at least one fastening plate 4 having an arc-shaped fastening groove. Two side walls of the toothed sliding block 6 are provided with sliding rails. Sliding grooves corresponding to the sliding rails are provided on a support rack of the fastening assembly. The sliding rails of the toothed sliding block 6 are inserted to the sliding grooves to drive the fastening assembly to move laterally. In the present embodiment, the fastening assembly comprises the support rack and two fastening plates 4 mounted on the support rack. The two fastening plates 4 are mounted on an upper end portion and a lower end portion of the support rack respectively.

The arc-shaped fastening groove of the at least one fastening plate 4 has a curvature that matches with a curvature of the bottle neck of the liquor bottle so that the at least one fastening plate 4 can be easily fastened on the bottle neck tightly and can be adaptable to be fastened on different bottle necks of different diameters. A bottle neck fastening strip 2 can be provided on the at least one fastening plate 4. The bottle neck fastening strip 2 is tilted upwardly. When the at least one fastening plate 4 is fastened on the bottle neck tightly, the bottle neck fastening strip 2 abuts against an upper portion of the bottle neck. The bottle neck fastening strip 2 can be inserted into and connected with an insertion slot of the at least one fastening plate 4.

A back side of the toothed piece 8 is provided with a cylindrical block having a metal surface covering its outer side. The compression spring 9 sleeves the outer side of the cylindrical block. The toothed surface 81 of the toothed piece 8 and the sliding block toothed surface 61 of the toothed sliding block 6 correspond to each other. During installation, the compression spring 9 sleeves the outer side of the cylindrical block of the toothed piece 8. When the operation handle 5 is not pressed downwardly, the compression spring 9 is not compressed, and the toothed piece 8 and the toothed sliding block 6 are partially engaged with each other. When the operation handle 5 is pressed downwardly, the fastening assembly is driven through its structural linkage with the structure of the present invention described above. When the operation handle 5 is pressed downwardly, the fastening assembly moves laterally towards an inner part of the sleeve portion 13 which is transparent so as to be fastened on the bottle neck of the liquor bottle inside the sleeve portion 13, also, the toothed sliding block 6 of the locking assembly presses against the toothed piece 8 and the compression spring 9 at the back side of the toothed piece 8 so as to compress the compression spring 9 that sleeves the cylindrical block of the toothed piece 8, accordingly, the toothed sliding block 6 is provided with a downward moving space and thus move downwardly, resulting in a new engagement position between the toothed sliding block 6 and the toothed piece 8. The new engagement position is attained when the fastening assembly is effectively fastened on the bottle neck of the liquor bottle and no more tighter fastening can be attained. Due to effective fastening effect on the bottle neck of the liquor bottle and also due to the structural linkage between the fastening assembly and the locking assembly, the fastening assembly tightly fastened on the bottle neck will not displace laterally or longitudinally under external force given that engagement between the toothed sliding block 6 and the toothed piece 8 is not changed in terms of their engagement position.

The operation principle of the present invention is described as follows: When the operation handle 5 is pressed downwardly, the toothed sliding block 6 is driven to move downwardly and presses against the toothed piece 8 and the compression spring 9 via the toothed surfaces 61, 81; when the compression spring 9 is compressed, a downward moving space allowing the toothed sliding block 6 to move downwardly is formed between the toothed sliding block 6 and the toothed piece 8; as the toothed sliding block 6 moves downwardly and compresses the fastening assembly so that the fastening assembly moves laterally towards an inner part of the sleeve portion 13, the fastening assembly will be fastened on the bottle neck of the liquor bottle; when the fastening assembly is already effectively fastened on the bottle neck of the liquor bottle and can no longer move further for further fastening effect, the toothed sliding block 6 structurally linked with the fastening assembly will also not be able to further move downwardly, and the toothed sliding block 6 will again engage and fix with the toothed piece 8 at a new engagement position; accordingly, the fastening assembly is in a static locked condition. To unlock, an unlocking device specifically made for the liquor bottle security device is placed near to the security portion 14; under magnetic effect, the toothed piece 8 disposed with the metal cylindrical block is driven to move outwardly and compress the compression spring 9; a gap is therefore created between the toothed piece 8 and the toothed sliding block 6; the toothed sliding block 6 moves upwardly due to resilience of the reset spring 7, also, the fastening assembly structurally linked with the toothed sliding block 6 returns to its initial position; accordingly, the bottle neck of the liquor bottle is no longer fastened and can be taken out freely. As such, the liquor bottle security device can be used repeatedly. Since the toothed sliding block 6 and the toothed piece 8 are engaged and locked, when external forces try to pry the fastening assembly inside the sleeve portion 13 to unlock the security device, the toothed sliding block 6 can still remain to be engaged with the toothed piece 8 achieving a static locked condition given that external motivating force to move the toothed sliding block 6 upwardly is not provided; due to structural linkage between the fastening assembly and the toothed sliding block 6, the fastening assembly is not provided with any room to move even if it is pried, therefore the fastening assembly is still effectively fastened on the bottle neck.

One side of the security portion 14 of the housing 12 is provided with a surface cover 11 which facilitates the installation, replacement and maintenance of the locking assembly. The surface cover 11 is provided with a reset portion 15. The compression spring 9 is mounted between the reset portion 15 and the toothed piece 8. A buffer block 10 is provided between the compression spring 9 and the reset portion 15. The toothed piece 8 is made of metal material, for example, iron. The fastening assembly comprises two fastening plates 4 to provide multiple fastening positions so as to prevent pulling by intrusive external forces and enhance the anti-theft performance of the fastening assembly. The fastening plates 4 and their corresponding bottle neck fastening strips 2 are made of plastic material or soft material covered with plastic material around its outer surface.

Although the present invention is described with reference to an embodiment, the embodiment described herein is not intended to limit the scope of the present invention. Any obvious changes to the above embodiment in accordance with the teaching of the present description should fall within the scope of protection defined by the appended claims.

What is claimed is:

1. A liquor bottle security device comprising a housing; wherein the housing comprises a sleeve portion and a security portion provided on one side of the sleeve portion; a locking assembly is installed inside the security portion; the locking assembly comprises a toothed sliding block, a toothed piece and a fastening assembly; a reset spring is provided between the toothed sliding block and the housing; a sliding block toothed surface of the toothed sliding block and a toothed surface of the toothed piece are cooperative with each other; the sliding block toothed surface of the toothed sliding block and the toothed surface of the toothed piece also engage with each another; the toothed sliding block is capable to only slide downwardly with respect to the toothed piece; a compression spring is provided between the toothed piece and an inner side wall of the security portion, so that the toothed piece is pressed against the sliding block toothed surface of the toothed sliding block; the toothed sliding block is provided with an inclined drive surface; the inclined drive surface contacts with the fastening assembly movably disposed in the housing; the fastening assembly comprises at least one fastening plate having an arc-shaped fastening groove.

2. The liquor bottle security device as claimed in claim 1, wherein a bottle neck fastening strip is provided on the at least one fastening plate.

3. The liquor bottle security device as claimed in claim 2, wherein the fastening assembly comprises a support rack and the at least one fastening plate comprising two fastening plates mounted on the support rack; the two fastening plates are mounted on an upper end portion and a lower end portion of the support rack respectively.

4. The liquor bottle security device as claimed in claim 3, wherein two side walls of the toothed sliding block are provided with sliding rails; sliding grooves corresponding to the sliding rails are provided on the fastening assembly; the sliding rails of the toothed sliding block are inserted to the sliding grooves.

5. The liquor bottle security device as claimed in claim 1, wherein the toothed sliding block is connected with an operation handle; the operation handle extends out of an upper cover of the housing; the reset spring is provided between a bottom part of the toothed sliding block and a top section of an inner surface of the housing.

6. The liquor bottle security device as claimed in claim 1, wherein the toothed piece is provided with a cylindrical block having a metal surface covering its outer side; the cylindrical block contacts with the compression spring.

7. The liquor bottle security device as claimed in claim 6, wherein one side of the housing is provided with a surface cover which facilitates installation, replacement and maintenance of the locking assembly.

8. The liquor bottle security device as claimed in claim 7, wherein the surface cover is provided with a reset portion; the compression spring is mounted between the reset portion and the toothed piece.

9. The liquor bottle security device as claimed in claim 8, wherein a buffer block is provided between the compression spring and the reset portion.
